(19) United States
(12) Patent Application Publication
(10) Pub. No.: US 2012/0254118 A1
(43) Pub. Date: Oct. 4, 2012

(54) RECOVERY OF TENANT DATA ACROSS TENANT MOVES

(75) Inventors: Siddharth Rajendra Shah, Bothell, WA (US); Antonio Marco Da Silva, JR., Kirkland, WA (US); Nikita Voronkov, Redmond, WA (US); Viktoriya Taranov, Bellevue, WA (US); Daniel Blood, Snohomish, WA (US)

(73) Assignee: MICROSOFT CORPORATION, Redmond, WA (US)

(21) Appl. No.: 13/077,620

(22) Filed: Mar. 31, 2011

(51) Int. Cl. G06F 17/30; G06F 7/00

(52) U.S. Cl. 707/645; 707/674; 707/640; 707/679; 707/E17.005

(57) ABSTRACT

A history of locations of tenant data is maintained. The tenant data comprises data that is currently being used by the tenant and the corresponding backup data. When a tenant's data is changed from one location to another, a location and a time is stored within the history that may be accessed to determine a location of the tenant's data at a specified time. Different operations trigger a storing of a location/time within the history. Generally, an operation that changes a location of the tenant's data triggers the storing of the location within the history (e.g. upgrade of farm, move of tenant, adding a tenant, load balancing of the data, and the like). When tenant data is needed for an operation (e.g. restore), the history may be accessed to determine the location of the data.

### BACKGROUND

Tenant data may be moved to different locations for various reasons. For example, tenant data may be moved when upgrading a farm, more space is needed for the tenant's data, and the like. In such cases, a new backup of the tenant data is made.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A history of locations of tenant data is maintained. The tenant data comprises data that is currently being used by the tenant and the corresponding backup data. When a tenant's data is changed from one location to another, a location and a time is stored within the history that may be accessed to determine a location of the tenant's data at a specified time. Different operations trigger a storing of a location/time within the history. Generally, an operation that changes a location of the tenant's data triggers the storing of the location within the history (e.g. upgrade of farm, move of tenant, adding a tenant, load balancing of the data, and the like). When tenant data is needed for an operation (e.g. restore), the history may be accessed to determine the location of the data.

### BRIEF DESCRIPTION OF THE DRAWINGS

FIG. 1 illustrates an exemplary computing environment;

FIG. 2 shows a system for maintaining a location of tenant data across tenant moves;

FIG. 3 shows a history including records for tenant data location changes;

FIG. 4 illustrates a process for updating a history of a tenant's data location change; and

FIG. 5 shows a process for processing a request for restoring tenant data from a backup location.

### DETAILED DESCRIPTION

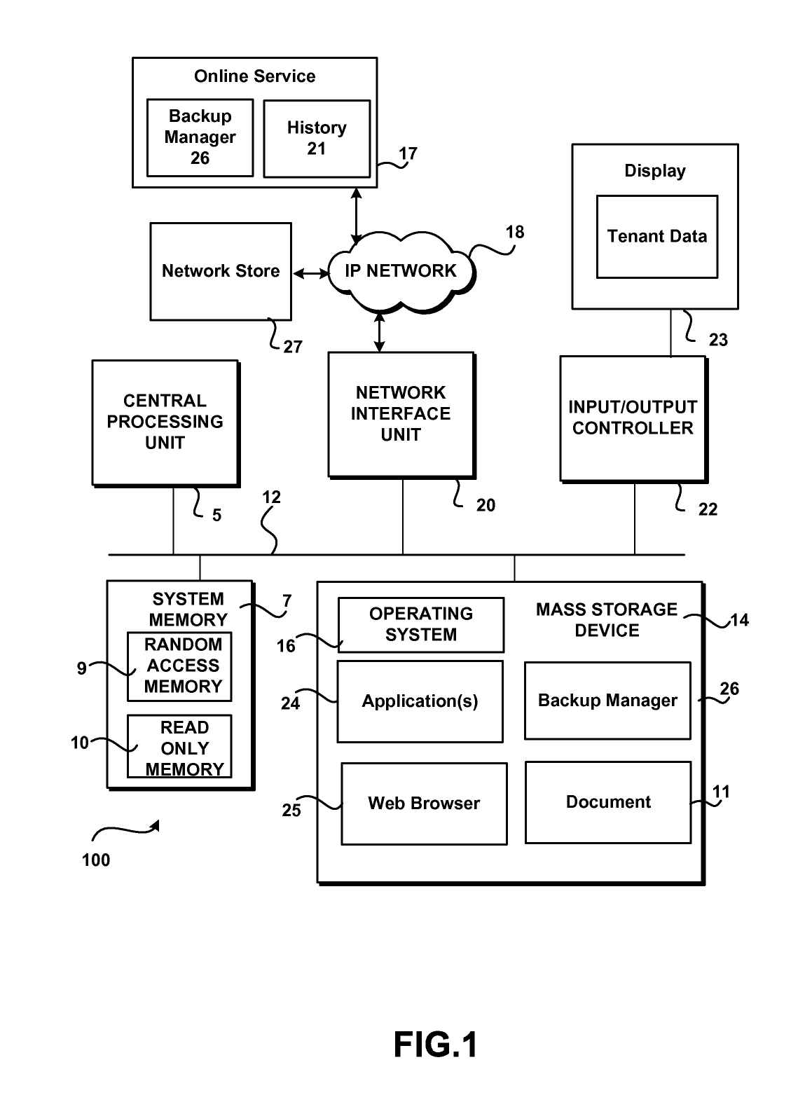

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a mobile computing device (e.g. phone, tablet, net book, laptop), server, a desktop, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, Web browser 25, and backup manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to a display screen 23, a printer, or other type of output device.

As mentioned briefly above, a number of program modules and data files may be stored in the mass storage device 14 and RAM 9 of the computer 100, including an operating system 16 suitable for controlling the operation of a computer, such as the WINDOWS 7®, WINDOWS SERVER®, or WINDOWS PHONE 7® operating system from MICROSOFT CORPORATION of Redmond, Wash. The mass storage device 14 and RAM 9 may also store one or more program modules. In particular, the mass storage device 14 and the RAM 9 may store one or more application programs, including one or more application(s) 24 and Web browser 25. According to an embodiment, application 24 is an application that is configured to interact with on online service, such as a business point of solution service that provides services for different tenants. Other applications may also be used. For example, application 24 may be a client application that is configured to interact with data. The application may be configured to interact with many different types of data, including but not limited to: documents, spreadsheets, slides, notes, and the like.

Network store 27 is configured to store tenant data for tenants. Network store 27 is accessible to one or more computing devices/users through IP network 18. For example, network store 27 may store tenant data for one or more tenants for an online service, such as online service 17. Other network stores may also be configured to store data for tenants. Tenant data may also move from on network store to another network store

Backup manager 26 is configured to maintain locations of tenant data within a history, such as history 21. Backup manager 26 may be a part of an online service, such as online service 17, and all/some of the functionality provided by backup manager 26 may be located internally/externally from an application. The tenant data comprises data that is currently being used by the tenant and the corresponding backup data. When a tenant's data is changed from one location to another, a location and a time is stored within the history 21 that may be accessed to determine a location of the tenant's data at a specified time. Different operations trigger a storing of a location/time within the history. Generally, an operation that changes a location of the tenant's data triggers the storing of the location within the history (e.g. upgrade of farm, move of tenant, adding a tenant, load balancing of the data, and the like). When tenant data is needed for an operation (e.g. restore), the history may be accessed to determine the location of the data. More details regarding the backup manager are disclosed below.

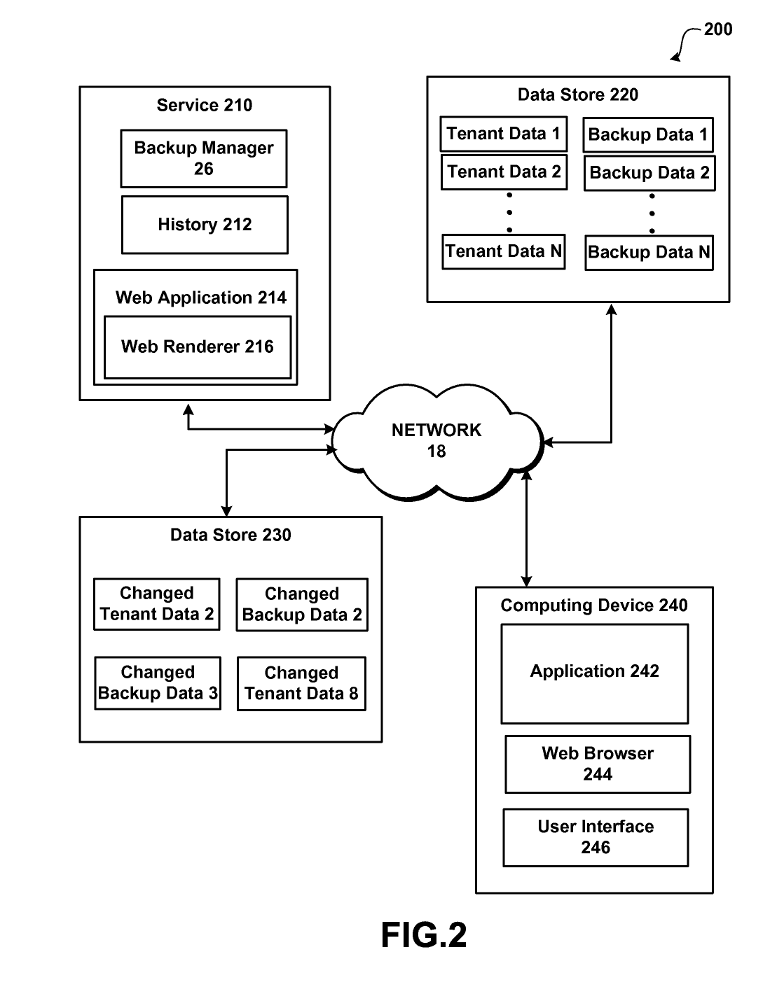

FIG. 2 shows a system for maintaining a location of tenant data across tenant moves. As illustrated, system 200 includes service 210, data store 220, data store 230 and computing device 240.

The computing devices used may be any type of computing device that is configured to perform the operations relating to the use of the computing device. For example, some of the computing devices may be: mobile computing devices (e.g. cellular phones, tablets, smart phones, laptops, and the like); some may be desktop computing devices and other computing devices may be configured as servers. Some computing devices may be arranged to provide an online cloud based service (e.g. service 210), some may be arranged as data shares that provide data storage services, some may be arranged in local networks, some may be arranged in networks accessible through the Internet, and the like.

The computing devices are coupled through network 18. Network 18 may be many different types of networks. For example, network 18 may be an IP network, a carrier network for cellular communications, and the like. Generally, network 18 is used to transmit data between computing devices, such as computing device 240, data store 220, data store 230 and service 210.

Computing device 240 includes application 242, Web browser 244 and user interface 246. As illustrated, computing device 240 is used by a user to interact with a service, such as service 210. According to an embodiment, service 210 is a multi-tenancy service. Generally, multi-tenancy refers to the isolation of data (including backups), usage and administration between customers. In other words, data from one customer (tenant 1) is not accessible by another customer (tenant 2) even though the data from each of the tenants may be stored within a same database within the same data store.

User interface (UI) 246 is used to interact with various applications that may be local/non-local to computing device 240. One or more user interfaces of one or more types may be used to interact with the document. For example, UI 246 may include the use of a context menu, a menu within a menu bar, a menu item selected from a ribbon user interface, a graphical menu, and the like. Generally, UI 246 is configured such that a user may easily interact with functionality of an application. For example, a user may simply select an option within UI 246 to select to restore tenant data that is maintained by service 210.

Data store 220 and data store 230 are configured to store tenant data. The data stores are accessible by various computing devices. For example, the network stores may be associated with an online service that supports online business point of solution services. For example, an online service may provide data services, word processing services, spreadsheet services, and the like.

As illustrated, data store 220 includes tenant data, including corresponding backup data, for N different tenants. A data store may store all/portion of a tenant's data. For example, some tenants may use more than one data store, whereas other tenants share the data store with many other tenants. While the corresponding backup data for a tenant is illustrated within the same data store, the backup data may be stored at other locations. For example, one data store may be used to store tenant data and one or more other data stores may be used to store the corresponding backup data.

Data store 230 illustrates a location of tenant data being changed and backup data being changed from a different data store. In the current example, tenant data 2 and the corresponding backup data has been changed from data store 220 to data store 230. Backup data for tenant 3 has been changed from data store 220 to data store 230. Tenant data 8 has been changed from data store 220 to data store 230. The location change may occur for a variety of reasons. For example, more space may be needed for a tenant, the data stores may be load balanced, the farm where the tenant is located may be upgraded, a data store may fail, a database may be moved/upgraded, and the like. Many other scenarios may cause a tenant's data to be changed. As can be seen from the current example, the tenant's data may be stored in one data store and the corresponding backup data may be stored in another data store.

Service 210 includes backup manager 26, history 212 and Web application 214 that comprises Web renderer 216. Service 210 is configured as an online service that is configured to provide services relating to displaying an interacting with data from multiple tenants. Service 210 provides a shared infrastructure for multiple tenants. According to an embodiment, the service 210 is MICROSOFT'S SHAREPOINT ONLINE service. Different tenants may host their Web applications/site collections using service 210. A tenant may also use a dedicated alone or in combination with the services provided by service 210. Web application 214 is configured for receiving and responding to requests relating to data. For example, service 210 may access a tenant's data that is stored on network store 220 and/or network store 230. Web application 214 is operative to provide an interface to a user of a computing device, such as computing device 240, to interact with data accessible via network 18. Web application 214 may communicate with other servers that are used for performing operations relating to the service.

Service 210 receives requests from computing devices, such as computing device 240. A computing device may transmit a request to service 210 to interact with a document, and/or other data. In response to such a request, Web application 214 obtains the data from a location, such as network share 230. The data to display is converted into a markup language format, such as the ISO/IEC 29500 format. The data may be converted by service 210 or by one or more other computing devices. Once the Web application 214 has received the markup language representation of the data, the service utilizes the Web renderer 216 to convert the markup language formatted document into a representation of the data that may be rendered by a Web browser application, such as Web browser 244 on computing device 240. The rendered data appears substantially similar to the output of a corresponding desktop application when utilized to view the same data. Once Web renderer 216 has completed rendering the file, it is returned by the service 210 to the requesting computing device where it may be rendered by the Web browser 244.

The Web renderer 216 is also configured to render into the markup language file one or more scripts for allowing the user of a computing device, such as computing device 240 to interact with the data within the context of the Web browser 244. Web renderer 216 is operative to render script code that is executable by the Web browser application 244 into the returned Web page. The scripts may provide functionality, for instance, for allowing a user to change a section of the data and/or to modify values that are related to the data. In response to certain types of user input, the scripts may be executed. When a script is executed, a response may be transmitted to the service 210 indicating that the document has been acted upon, to identify the type of interaction that was made, and to further identify to the Web application 214 the function that should be performed upon the data.

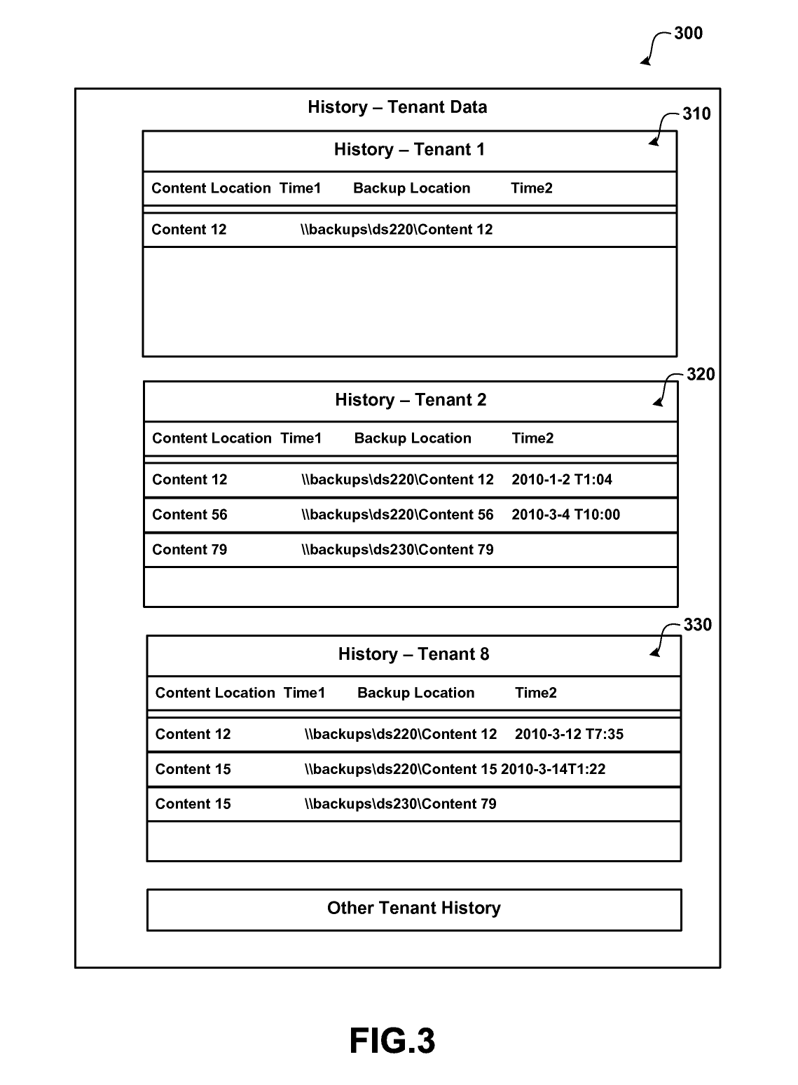

In response to an operation that causes a change in location of a tenant's data, backup manager 26 places an entry into history 212. History 212 maintains a record of the locations for the tenant's data and corresponding backup data. According to an embodiment, history 212 stores the database name and location that is used to store the tenant's data, a name and location of the backup location for the tenant's data and the time the data is stored at that location (See FIG. 3 and related discussion). The history information may be stored in a variety of ways. For example, history records for each tenant may be stored within a database, history information may be stored within a data file, and the like.

According to an embodiment, backup manager 26 is configured to perform full backups of tenant data and incremental backups and transaction log entries between the times of the full backups. The scheduling of the full backups is configurable. According to an embodiment, full backups are performed weekly, incremental backups are performed daily and transactions are stored every five minutes. Other schedules may also be used and may be configurable. The different backups may be stored in a same locations and/or different locations. For example, full backups may be stored in a first location and the incremental and transaction logs may be stored in a different location.

FIG. 3 shows a history including records for tenant data location changes. History 300 includes records for each tenant that is being managed. For example purposes, history 300 shows history records for Tenant 1 (310), Tenant 2 (320) and Tenant 8 (330).

As illustrated, history record 310 was created in response to Tenant 1 being added. According to an embodiment, a history record comprises fields for a content location, a time, a backup location and a time. The content location provides information on where the tenant's content is stored (e.g. a database name, a URL to the content location, and the like). The Time1 field indicates a last time the tenant's data was at the specified location. According to an embodiment, when the Time1 field is empty, the Time2 value is used for the record. When the Time1 field and the Time2 field are both empty, the data is still located at the content location and the backup location listed in the record. The backup location field specifies a location of where the backup for the content is located. The Time2 field specifies a last time the tenant's backup data was at the specified location.

Referring to the history for Tenant1 (310) it can be seen that Tenant 1's data is located at content location “Contentl2” (e.g. a name of a database) and that the backup data for Tenant 1's data is located at “backups\ds220\Content 12.” In this case, Tenant 1's data has not changed location since Tenant 1 was added.

Tenant 2's data has changed locations from “Content 12” to “Content 56” to “Content 79.” Before Mar. 4, 2010 at 10 AM and after Jan. 2, 2010 at 1:04 AM the data is stored at “Content 56” and the corresponding backup data is stored at “backups\ds220\Content 56.” Before Jan. 2, 2010 at 1:04 AM the data is stored at “Content 12” and the corresponding backup data is stored at “backups\ds220\Content 12.”

Tenant 3's data has changed locations from “Content 12” to “Content 15.” The corresponding backup data has changed from “backups\ds220\Content 12” to “backups\ds220\Content 15” to “backups\ds230\Content 79.” Tenant's 3 data is stored at “Content 15” after Mar. 12, 2010 at 7:35 AM. Before Mar. 24, 2010 at 1:22 AM and after Mar. 12, 2010 at 7:35 AM the corresponding backup data is stored at “backups\ds220\Content 15.” Before Mar. 12, 2010 at 7:35 AM the data is stored at “Content 12” and the corresponding backup data is stored at “backups\ds220\Content 12.” In the current example, Tenant 3's location of the backup data changed without changing the location of the Tenant data from “Content 15.”

Many other ways may be used to store the information relating to the location of tenant data. For example, the time field could include a start time and an end time, a start time and no end time, or an end time and no start time. The location could be specified as a name, an identifier, a URL, and the like. Other fields may also be included, such as a size field, a number of records field, a last accessed field, and the like.

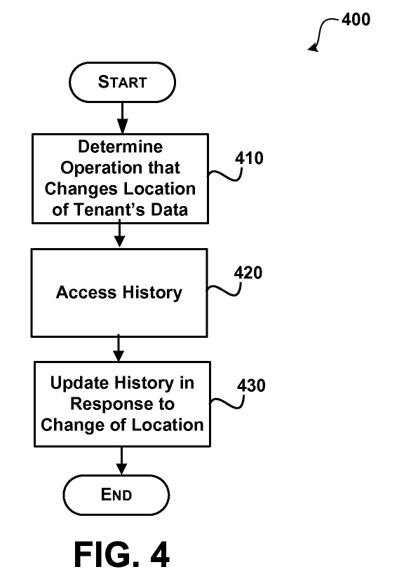

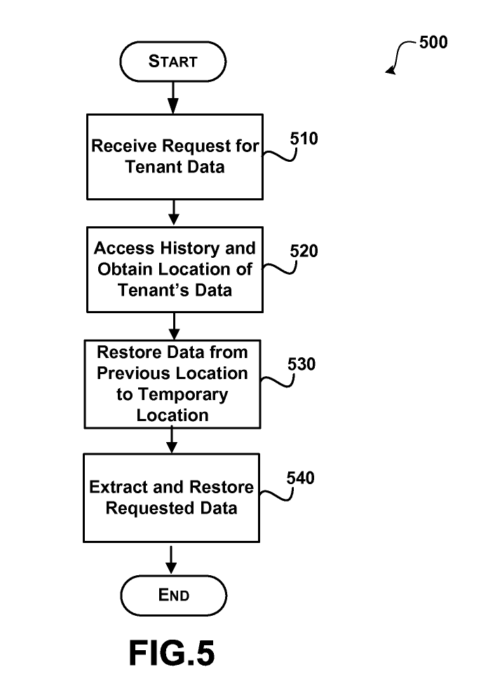

FIGS. 4 and 5 show an illustrative process for recovering tenant data across tenant moves. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 4 illustrates a process for updating a history of a tenant's data location change.

After a start block, process 400 moves to operation 410, where a determination is made that an operation has changed a location of a tenant's data. The change may relate to all/portion of a tenant's data. Many different operations may cause a change in a location of tenant data. For example, adding a tenant, farm upgrade, moving of tenant, load balancing the tenant's data, load balancing the corresponding backup data, a maintenance operation, a failure, and the like. Generally, any operation that causes the tenant's data and/or corresponding backup data to change locations is determined.

Flowing to operation 420, the history for the tenant whose data is changing location is accessed. The history may be accessed within a local data store, a shared data store and/or some other memory location.

Moving to operation 430, the history for the tenant is updated to reflect a current state and any previous states of the tenant's data. According to an embodiment, each tenant includes a table indicating its corresponding history. The history may be stored using many different methods using many different types of structures. For example, the history may be stored in a memory, a file, a spreadsheet, a database, and the like. History records may also be intermixed within a data store, such as within a list, a spreadsheet and the like. According to an embodiment, a history record comprises fields for a content location, a time, a backup location and a time. The content location provides information on where the tenant's content is stored (e.g. a database name, a URL to the content location, and the like). The Time1 field indicates a last time the tenant's data was at the specified location. According to an embodiment, when the Time1 field is empty, the Time1 value is the same as the Time2 field. When the Time1 field and the Time2 field are empty, the data is still located at the content location and the backup location. The backup location field specifies a location of where the backup for the content is located. The Time2 field specifies a last time the tenant's backup data was at the specified location.

The process then flows to an end block and returns to processing other actions.

FIG. 5 shows a process for processing a request for restoring tenant data from a previous location.

After a start block, the process moves to operation 510, where a request is received to restore tenant data. For example, a tenant may have accidentally deleted data that they would like to restore. According to an embodiment, the request includes a time indicating when they believe that they deleted the data. According to another embodiment, a time range may be given. According to yet another embodiment, each location within the tenant's history may be searched for the data without providing a time within the request.

Flowing to operation 520, the history for the tenant is accessed to determine where the data is located. As discussed above, the history includes a current location of tenant data and corresponding backup data and each of the previous locations of the data.

Moving to operation 530, the tenant's data is restored to a temporary location such that the tenant's current data is not overwritten with unwanted previous data.

Transitioning to operation 540, the requested data is extracted from the temporary location and restored to the current location of the tenant's data. The data at the temporary location may be erased.

The process then flows to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for recovering tenant data across tenant moves, comprising:
determining an operation that changes a location of a tenant's data;
in response to the operation that changes the location of the tenant's data, updating a history of the tenant's data by adding a current location of the tenant's data; and
when requested, accessing the history to determine a previous location of the tenant's data.

2. The method of claim 1, wherein the history is updated in response to a load balancing of at least one of: tenant data and backup data.

3. The method of claim 1, wherein the history is updated in response to a tenant move.

4. The method of claim 1, wherein the history is updated in response to a farm upgrade.

5. The method of claim 1, wherein updating the history comprises storing a location of backup data that corresponds to the tenant's data.

6. The method of claim 5, wherein the backup data comprises a full backup of the tenant's data and incremental backups of the tenant's data and transaction log backups of the tenant's data.

7. The method of claim 1, wherein updating the history comprises including a time indicating when the tenant's data is moved from the previous location the current location.

8. The method of claim 7, further comprising determining the previous location of the tenant's data by accessing the location based upon a comparison of a specified time with the time within the history.

9. The method of claim 1, further comprising restoring the data to a temporary location and extracting requested data from the temporary location and placing the extracted data into the current location of the tenant's data.

10. A computer-readable storage medium storing computer-executable instructions for recovering tenant data across tenant moves, comprising:
determining an operation that changes a location of a tenant's data;
updating a history of the tenant's data to include a current location of the tenant's data, wherein the history includes a record for each location at which the tenant's data has been stored and the current location, wherein each record comprises a tenant data location, a backup location for the tenant data, and time information indicating when the data was at each of the locations; and
when requested, accessing the history to determine a previous location of the tenant's data.

11. The computer-readable storage medium of claim 10, wherein the history is updated in response to at least one of: a load balancing on at least one of:
tenant data and backup data; a tenant move; and a farm upgrade.

12. The computer-readable storage medium of claim 10, further comprising providing each location of the backup of tenant's data in response to the request.

13. The computer-readable storage medium of claim 12, wherein the backup data comprises a full backup of the tenant's data, incremental backups of the tenant's data, and transaction log data.

14. The computer-readable storage medium of claim 10, wherein updating the history comprises including a time indicating when the tenant's data is moved from the previous location to the current location.

15. The computer-readable storage medium of claim 14, further comprising determining the previous location of the tenant's data by accessing the location based upon a comparison of a specified time with the time within the history.

16. The computer-readable storage medium of claim 10, further comprising restoring the data to a temporary location and extracting requested data from the temporary location and placing the extracted data into the current location of the tenant's data.

17. A system for recovering tenant data across tenant moves, comprising:
a network connection that is configured to connect to a network;
a processor, memory, and a computer-readable storage medium;
an operating environment stored on the computer-readable storage medium and executing on the processor;
a data store storing tenant data that is associated with different tenants; and
a backup manager operating that is configured to perform actions comprising:
receiving a request for a tenant's data;
accessing a history of tenant data locations to determine a location of the requested tenant data, wherein the history includes a record for each location at which the tenant's data has been stored and the current location, wherein the record comprises a tenant data location, a backup location for the tenant data, and time information indicating when the data was at each of the locations.

18. The system of claim 17, further comprising comparing a time specified within the request to determine the location of the requested tenant data.

19. The system of claim 17, further comprising examining each location within the history to determine the location of the requested tenant data.

20. The system of claim 17, further comprising restoring the tenant's data to a temporary location and extracting the requested data from the temporary location and placing the extracted data into the current location of the tenant's data.
